(19) United States
(12) Patent Application Publication
(10) Pub. No.: US 2025/0085490 A1
(43) Pub. Date: Mar. 13, 2025

(54) OPTOELECTRONIC DEVICE WITH A PHOTONIC INTERPOSER FOR CHIPLET INTERCONNECTS

(71) Applicant: National University of Singapore, Singapore (SG)

(72) Inventors: Zefeng XU, Singapore (SG); Chun-Kuei CHEN, Singapore (SG); Aaron Voon-Yew THEAN, Singapore (SG)

(21) Appl. No.: 18/829,811

(22) Filed: Sep. 10, 2024

(30) Foreign Application Priority Data
Sep. 12, 2023 (SG) 10202302560X

(51) Int. Cl. G02B 6/42

(52) U.S. Cl. CPC G02B 6/4206

(57) ABSTRACT

This document describes an optoelectronic device comprising a photonic interposer that is provided with a plurality of chiplets and a multimode waveguide. Each of the plurality of chiplets are communicatively connected to a micro-ring resonator router that is provided adjacent to each chiplet, and each micro-ring resonator router is electromagnetically coupled to the multimode waveguide such that each of the micro-ring resonators are able to selectively couple optical signals propagating in the multimode waveguide

### CROSS-REFERENCE TO RELATED APPLICATION

This application claims the benefit of priority to Singapore patent application no. 10202302560X which was filed on 12 Sep. 2023, the contents of which are hereby incorporated by reference in its entirety for all purposes.

### TECHNICAL FIELD

This application relates to an optoelectronic device comprising a photonic interposer that is provided with a plurality of chiplets and a multimode waveguide. Each of the plurality of chiplets are communicatively connected to a micro-ring resonator router that is provided adjacent to each chiplet, and each micro-ring resonator router is electromagnetically coupled to the multimode waveguide such that each of the micro-ring resonators are able to selectively couple optical signals propagating in the multimode waveguide.

### BACKGROUND

Chiplet technology involves the creation of smaller, specialized modular chips (chiplets) that may be interconnected to form a complete system. Through the use of such chiplets, large integrated circuits may be divided into smaller, modular units to address yield limitations. While this approach has enabled picojoule-level (pJ-level) energy consumption for achieving exceptional terabits per second (Tb/s) data throughput within chiplets, this approach faces significant efficiency challenges when it comes to inter-chiplet connections. These challenges arise due to the scaling of interconnections and limitations in pin count and signal integrity, which hinder the overall performance of the system.

Optical interconnects offer a promising solution to the bottleneck in inter-chiplet communication by providing low-latency, low-loss data transmission. However, the current state-of-the-art optical solutions are limited by the relatively large area required for optical devices and the heat sensitivity associated with lasers. High-speed modulators, despite their advantages, also consume substantial energy. Additionally, the use of fixed interconnects after fabrication restricts system flexibility and can lead to resource inefficiencies, further reducing the effectiveness of the overall system.

As such, those skilled in the art are continually seeking solutions to optimize interconnectivity between the chiplets by adopting innovative means that improve the system's power efficiency, increase the speed of data transmission between the chiplets and introduce the for reconfigurable optical interconnects.

### SUMMARY

In one aspect, the present disclosure describes an optoelectronic device comprising a photonic interposer having a conductive layer formed on a base substrate and an oxide or dielectric layer formed on the conductive layer such that the conductive layer is interposed between the oxide layer and the base substrate. The oxide layer of the photonic interposer further comprises first and second chiplets that are attached to the surface of the oxide layer. A first micro-ring resonator (MRR) router is disposed on the surface of the oxide layer adjacent to the first chiplet, and the first MRR router is communicatively connected to the first chiplet through a first conductive interconnect layer formed within the oxide layer. A second MRR router is disposed on the surface of the oxide layer adjacent to the second chiplet, and the second MRR router is communicatively connected to the second chiplet through a second conductive interconnect layer formed within the oxide layer. The photonic interposer also has a multimode waveguide that has a first end for receiving optical signals and a second end for transmitting optical signals being formed on the surface of the oxide layer. The waveguide is formed adjacent to the first and the second MRR routers such that the multimode waveguide is electromagnetically coupled to the first and the second MRR routers. Each of the first and second MRR routers further comprises a micro-ring modulator and a memory module.

In a further embodiment of this aspect, a multi-wavelength multiplexer is formed on the surface of the oxide layer for receiving and combining multi-wavelength optical signals from a laser bank, the multi-wavelength multiplexer being optically coupled to the first end of the multimode waveguide.

In yet a further embodiment of this aspect, the present disclosure describes a micro-ring modulator of the first MRR router that is configured to resonate at a first wavelength. While the micro-ring modulator is resonating at the first wavelength, it selectively couples an optical signal having the first wavelength from the combined multi-wavelength optical signals that are propagating in the multimode waveguide. It then modulates the coupled optical signal based on data contained in a memory module of the first MRR router and once done, proceeds to couple the modulated optical signal back to the multimode waveguide such that the coupled modulated optical signal then continues to propagate through the multimode waveguide. A micro-ring modulator of the second MRR router is then configured to resonate at the first wavelength. While the micro-ring modulator of the second MRR router is resonating at the first wavelength, it selectively couples the modulated optical signal having the first wavelength from the optical signals propagating in the multimode waveguide. The modulated optical signal is then optically coupled to a high-speed photodetector formed on the surface of the oxide layer adjacent to the second chiplet and the second MRR router. In embodiments of the disclosure, the high-speed photodetector then converts optical signals received by the second MRR router into electrical signals and provides the converted electrical signals to the second chiplet.

In another aspect, the present disclosure describes a method for forming an optoelectronic device. A photonic interposer is initially formed by the steps of forming a conductive layer on a base substrate and forming an oxide or dielectric layer on the conductive layer such that the conductive layer is interposed between the oxide layer and the base substrate. The method then comprises the steps of attaching a first chiplet to a surface of the oxide layer of the photonic interposer, forming a first micro-ring resonator (MRR) router on the surface of the oxide layer adjacent to the first chiplet, the first MRR router being communicatively connected to the first chiplet through a first conductive interconnect layer formed within the oxide layer, attaching a second chiplet to the surface of the photonic interposer, forming a second MRR router on the surface of the oxide layer adjacent to the second chiplet, the second MRR router being communicatively connected to the second chiplet through a second conductive interconnect layer formed within the oxide layer, and forming a multimode waveguide, having a first end for receiving optical signals and a second end for transmitting optical signals, on the surface of the oxide layer adjacent to the first and the second MRR routers such that the multimode waveguide is electromagnetically coupled to the first and the second MRR routers, wherein the first and second MRR routers each comprise a micro-ring modulator and a memory module.

In another embodiment of this aspect, the present disclosure describes a method for forming a high-speed photodetector on the surface of the oxide layer adjacent to the second chiplet and the second MRR router, converting, using the high-speed photodetector, optical signals received by the second MRR router into electrical signals, and providing, using the high-speed photodetector, the converted electrical signals to the second chiplet. In embodiments of this aspect, the high-speed photodetector comprises a drop waveguide and a photodiode, wherein the drop waveguide was formed on the surface of the oxide layer adjacent the second MRR router such that the drop waveguide is electromagnetically coupled with a micro-ring modulator of the second MRR router, and the photodiode was attached to the surface of the oxide layer and optically connected to the drop waveguide and communicatively connected to the second chiplet.

### BRIEF DESCRIPTION OF THE DRAWINGS

Various embodiments of the present disclosure are described below with reference to the following drawings:

FIG. 1 illustrates a perspective view of an optoelectronic device having a photonic interposer, a plurality of chiplets that are each provided a micro-ring resonator (MRR) router and a multimode waveguide in accordance with an embodiment of the present disclosure;

FIG. 2 illustrates a cross-sectional view of the optoelectronic device illustrated in FIG. 1 in accordance with an embodiment of the present disclosure;

FIG. 3 illustrates a top view of an optoelectronic device having a photonic interposer and a plurality of optically interconnected chiplets in accordance with an embodiment of the present disclosure;

FIG. 4 illustrates a flowchart of a process to form an optoelectronic device in accordance with an embodiment of the present disclosure;

FIG. 5 illustrates an operational flow of a MRR router in an optoelectronic device in accordance with an embodiment of the present disclosure;

FIG. 6a illustrates the benchmarking results when the optoelectronic device is benchmarked against model reference architectures that utilize 10 nm CMOS technology for various algorithms;

FIG. 6b illustrates the benchmarking results when the optoelectronic device is benchmarked against model reference architectures that utilize 10 nm CMOS technology for various topologies; and

FIG. 6c illustrates the benchmarking results when the optoelectronic device is benchmarked against model reference architectures that utilize 10 nm CMOS technology for various chiplet numbers.

### DETAILED DESCRIPTION

The following detailed description is made with reference to the accompanying drawings, showing details and embodiments of the present disclosure for the purposes of illustration. Features that are described in the context of an embodiment may correspondingly be applicable to the same or similar features in the other embodiments, even if not explicitly described in these other embodiments. Additions and/or combinations and/or alternatives as described for a feature in the context of an embodiment may correspondingly be applicable to the same or similar feature in the other embodiments.

In the context of various embodiments, the articles “a”, “an” and “the” as used with regard to a feature or element include a reference to one or more of the features or elements.

In the context of various embodiments, the term “about” or “approximately” as applied to a numeric value encompasses the exact value and a reasonable variance as generally understood in the relevant technical field, e.g., within 10% of the specified value.

As used herein, the term “and/or” includes any and all combinations of one or more of the associated listed items.

As used herein, “comprising” means including, but not limited to, whatever follows the word “comprising”. Thus, use of the term “comprising” indicates that the listed elements are required or mandatory, but that other elements are optional and may or may not be present.

As used herein, “consisting of” means including, and limited to, whatever follows the phrase “consisting of”. Thus, use of the phrase “consisting of” indicates that the listed elements are required or mandatory, and that no other elements may be present.

In the context of various embodiments, the term “surround” means to enclose something completely to form a barrier around it. Thus, the use of the term “surround” indicates that something is on all sides of another thing.

In the context of various embodiments, the term “disposed on” relates to the placement or deposition of one material or layer onto the surface of another and may involve one or more types of deposition techniques.

In the context of various embodiments, the term “around” or “adjacent” means to be in the proximity or location of something and does not necessarily mean that two objects have to be in contact.

In the context of various embodiments, the directional terms mentioned herein, such as “above” and “below” or “upper” and “lower” refer to directions as described with reference to the drawings. Therefore, the directional terms are only used for illustration and are not meant to limit the present disclosure.

It should be noted that although the terms first, second and third are used herein to describe various elements, these elements should not be limited by these terms as these terms are meant to only distinguish one element from another element. Thus, the first element described herein could be termed as a second element without departing from this disclosure.

As used herein, a “layer” refers to a material portion including a region having a particular thickness. The layer may extend over the entirety of the structure or may cover only part of the structure as defined in the description. For example, a layer may be located between two horizontal planes; may be located between, or at, a top surface and a bottom surface of the structure. The layer may also extend horizontally, vertically, and/or along the surface of the structure.

As used herein, the term “electromagnetically coupled” in the context of two or more waveguides refers to the interaction of optical signals traveling in these two or more waveguides through electromagnetic fields rather than direct physical or electrical contact. Such a coupling occurs when the electromagnetic field generated by optical signals in one waveguide induces a corresponding response in another nearby waveguide.

Additionally, for the sake of brevity, extensive explanations of conventional techniques of fabricating semiconductor devices and integrated circuits are not described in detail herein. The tasks and processes described herein may also be integrated into a more comprehensive procedure with extra steps of features that are not elaborated upon in this document. Specifically, certain processes of fabricating semiconductor devices are well known to one skilled in the art hence, such processes will be omitted entirely.

Photonic interposers are one-piece devices comprising photonic circuits formed of passive and active optical components. Microelectronic chips comprising integrated circuits and/or electronic components may also be physically attached to, and electrically connected to the photonic interposer. The active optical components provided on the photonic interposer may include electro-optical and/or thermo-optical components that act as the electronic interface between the photonic circuits and the microelectronic chips.

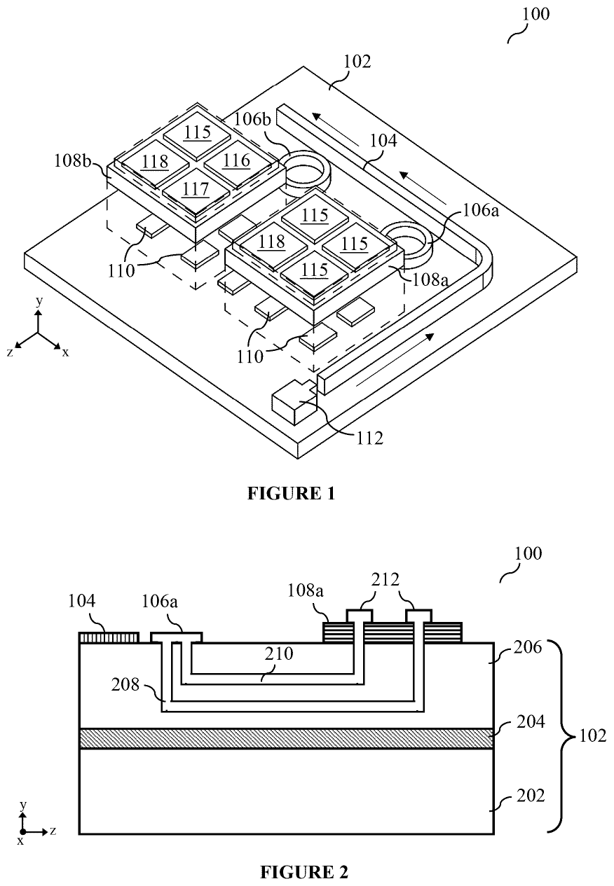

A perspective view of an optoelectronic device in accordance with embodiments of the present disclosure is illustrated in FIG. 1. As illustrated, optoelectronic device 100 comprises chiplets 108a and 108b, that are joined or attached to photonic interposer 102 through the use of metal contacts 110 and multi-ring resonators (MRRs) 106a and 106b that are formed on photonic interposer 102 adjacent to chiplets 108a and 108b respectively. In embodiments of the disclosure, micro-ring resonators 106a and 106b each comprise a compact and circular optical waveguide that may be used to selectively filter or route light at specific wavelengths when the MRR resonates at those wavelengths. In embodiments of the disclosure, chiplet 108b and corresponding MRR 106b are located “downstream” (i.e., along the path a signal takes after leaving a chiplet) of chiplet 108a and corresponding MRR 106a such that chiplet 108b receives data transmitted by chiplet 108a as the optical signals propagate along waveguide 104.

Optoelectronic device 100 also comprises multimode waveguide 104 that is formed on photonic interposer 102, adjacent to MRRs 106a and 106b such that MRRs 106a and 106b electromagnetically couples optical signals that may be propagating in multimode waveguide 104, i.e., multimode waveguide 104 is electromagnetically coupled to MRRs 106a and 106b. In embodiments of the disclosure, optoelectronic device may also be provided with an optical source 112 which may comprise a diode laser, solid-state lasers and any other light source. In the arrangement illustrated in FIG. 1, multimode waveguide 104 is configured to receive optical signals from optical source 112 at one end, and to transmit optical signals that have propagated through waveguide 104 at another end.

Chiplets 108a and 108b comprise combinations of memory component 115, input/output interface 116, graphics processing unit (GPU) 117 and/or processing unit 118. Herein, the term “processing unit” is used to refer generically to any device or component that can process instructions and may include: a core, a microprocessor, a processor, a plurality of processing elements, a microcontroller, a programmable logic device or any other type of computational device. That is, processing unit 118 may be provided by any suitable logic circuitry for receiving inputs, processing them in accordance with instructions stored in memory component 115 and generating outputs (for example to the memory components or to the multi-ring resonator routers). In this embodiment, processing unit 118 may be a single core or multi-core processor with memory addressable space. In one example, processing unit 118 may be multi-core, comprising—for example—an 8 core CPU, or it could be a cluster of CPU cores operating in parallel to accelerate computations. In embodiments of the disclosure, GPU 117 may comprise a specialized processor designed to handle parallel processing tasks, making it ideal not only for graphics-related computations but also for general-purpose computing tasks like machine learning and scientific simulations. One skilled in the art will recognize that chiplet 108 may comprise of other electronic components and/or memory components and the components illustrated in FIG. 1 are shown as a non-limiting exemplary configuration of such a chiplet.

Memory component 115 include both volatile and non-volatile memory and may include more than one of each type of memory, including Random Access Memory (RAM), Read Only Memory (ROM) or a mass storage device, the last comprising one or more solid-state drives (SSDs). One skilled in the art will recognize that the memory components described above comprise non-transitory computer-readable media and shall be taken to comprise all computer-readable media except for a transitory, propagating signal. Typically, the instructions are stored as program code in the memory components but can also be hardwired. Memory component 115 may include a kernel and/or programming modules such as a software application that may be stored in either volatile or non-volatile memory.

It should be noted that an orthogonal three-dimensional coordinate system x-y-z is defined in FIGS. 1 and 2, in which the x- and z-axes form a plane parallel to the main plane of photonic interposer 102, and in which the +y axis is oriented in a perpendicular direction to a surface of photonic interposer 102.

A cross-sectional view of optoelectronic device 100 along the y-z plane is illustrated in FIG. 2. As shown, photonic interposer 102 is formed from a stack of layers comprising conductive layer 204 that is sandwiched between base substrate 202 and dielectric layer 206. In embodiments of the disclosure, conductive layer 204 is formed on base substrate 202, whereby base substrate 202 may comprise, but is not limited to, silicon, silicon dioxide, silicon nitride, etc., while conductive layer 204 may comprise any conductive material such as gold, platinum, aluminum, etc. or solder/conductive balls comprising a conductive material. Dielectric layer 206 is then formed on conductive layer 204 such that conductive layer 204 is interposed or sandwiched between dielectric layer 206 and base substrate 202. In embodiments of the disclosure, dielectric layer 206 may comprise of any insulating materials such as silicon dioxide, silicon nitride, etc.

As illustrated in FIG. 2, chiplet 108a is attached to a surface of dielectric layer 206. Micro-ring resonator (MRR) 106a and multimode waveguide 104 are also disposed on the surface of dielectric layer 206 such that MRR 106a is electromagnetically coupled to multimode waveguide 104. Electronic components 212, which are provided on chiplet 108a, are communicatively connected to MRR 106a through conductive interconnects 208 and/or 210, which are formed within dielectric layer 206. In embodiments of the disclosure, each processing unit of chiplet 108a may be connected to MRR 106a via its own conductive interconnect formed within dielectric layer 206 or the processing units may share a single conductive interconnect formed within dielectric layer 206. In embodiments of the disclosure, electronic components may comprise, but is not limited to, combinations of memory component 115, input/output interface 116, GPU 117 and/or processing unit 118.

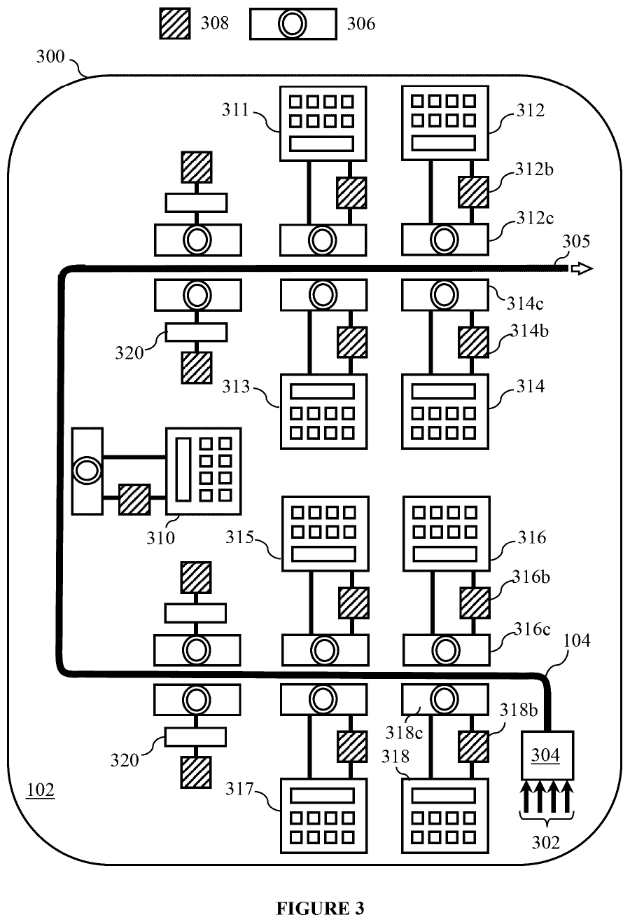

FIG. 3 illustrates a top view of dynamic photonic interconnect system 300 comprising a plurality of chiplets 310-318 that are attached to a surface of photonic interposer 102, and multimode waveguide 104 and multi-wavelength multiplexer 304 that are formed on the surface of photonic interposer 102, whereby multi-wavelength multiplexer 304 is optically coupled to an end of multimode-waveguide 104. Each of chiplets 310-318 comprises a micro-ring resonator (MRR) router, wherein each MRR router comprises micro-ring modulator 306, which performs as a channel selector and high-speed encoder/decoder, and memory module 308. Although FIG. 3 illustrates that system 100 comprises chiplets 310-318, one skilled in the art will recognize that system 100 may comprise any number of chiplets and that the number of chiplets attached to photonic interposer 102 is just for illustrative purposes only.

In operation, multi-wavelength optical signals 302, that may be generated by a laser bank, are first provided to multiplexer 304. In embodiments of the disclosure, the laser bank may be integrated into system 300 and may house individual lasers that generate optical signals of different wavelengths. Upon receiving the multi-wavelength optical signals, multiplexer 304 combines these signals and optically couples the combined optical signals to multimode waveguide 104. The combined multi-wavelength optical signals then propagate through multimode waveguide 104 until it is transmitted at end 305 of waveguide 104. As the combined multi-wavelength optical signals propagate through multimode waveguide 104, system 300 is able to achieve multi-channel capability as optical signals with specific wavelengths may be selectively coupled and encoded, and/or coupled and decoded according to the resonant frequency of each micro-ring modulator 306.

In an embodiment of the disclosure, a router controller (not shown) may be communicatively connected to chiplets 310-318 and may be used to identify available optical channels (i.e., free wavelengths) in multimode waveguide 104 for communication between any of chiplets 310-318. For example, if the router controller determines that chiplet 318 intends to communicate with chiplet 312, the router controller will first identify and select an optical signal having a specific wavelength from the combined multi-wavelength optical signals propagating through multimode waveguide 104 to establish a photonic communication channel between chiplets 318 and 312. For instance, the router controller may choose to use an optical signal at a first wavelength λ₁ from the propagating combined multi-wavelength optical signals. At the same time, the router controller may cause the time-series data to be communicated to chiplet 318 to be stored into memory module 318c associated with chiplet 318.

As the optical signal having the first wavelength λ₁ is selected by the router controller, micro-ring modulator 318c associated with chiplet 318 will then be triggered to resonate at the first wavelength λ₁. When the combined optical signals pass by micro-ring modulator 318c, the optical signal having the first wavelength λ₁ will be selectively electromagnetically coupled into micro-ring modulator 318c.

Once the optical signal at the first wavelength λ₁ has been electromagnetically coupled into micro-ring modulator 318c, the coupled signal begins to resonate within micro-ring modulator 318c, causing the optical signal to circulate within the ring structure. While the optical signal is resonating in micro-ring modulator 318c, the time-series data stored in memory module 318b is used by chiplet 318 to modulate the optical signal circulating within micro-ring modulator 318c. In embodiments of the disclosure, the modulation of the optical signal may be achieved by altering the refractive index of the material in micro-ring modulator 318c. This change in refractive index may be controlled by applying an electric field, which may be directly correlated with the data retrieved from the memory module, i.e. through the electro-optic effect. In embodiments of the disclosure, the change in the refractive index may additionally be controlled by applying heat to the material in micro-ring modulator 318c, i.e., through the thermo-optic effect.

The modulation process encodes the time-series data onto the optical signal by varying the phase, amplitude, or frequency of the light as it resonates in micro-ring modulator 318c. For example, the electric field applied to micro-ring modulator 318c may shift the resonant wavelength slightly, where this shift can be used to represent different bits of data (e.g., a phase shift could represent a binary ‘1’ or ‘0’). In another example, the amplitude of the resonating light might be modulated to encode the data. Regardless of the modulation technique used, the result is the creation of an optical signal that carries the encoded information as it circulates within micro-ring modulator 318c.

Once the optical signal is fully modulated with the data contained in memory module 318b, the modulated optical signal exits micro-ring modulator 318c and re-couples into the multimode waveguide 104 through electromagnetic coupling. This occurs as the optical signal in micro-ring modulator 318c continuously interacts with the evanescent field of multimode waveguide 104. As a result, when the resonance condition within micro-ring modulator 318c is altered (through modulation or natural decay), the optical signal begins to transfer back into waveguide 104. The modulated optical signal, now carrying the encoded data, propagates through multimode waveguide 104 towards its destination, chiplet 312.

As chiplet 312 is meant to receive the encoded data, micro-ring modulator 312c associated with chiplet 312 is triggered to resonate at the first wavelength λ₁. When the combined optical signals pass by micro-ring modulator 312c, the modulated optical signal at the first wavelength λ₁ is selectively electromagnetically coupled into micro-ring modulator 312c. The modulated optical signal circulating in micro-ring modulator 312c is then coupled to a high-speed photodetector (not shown) formed on the surface of photonic interposer 102, adjacent to micro-ring modulator 312c.

In embodiments of the disclosure, the high-speed photodetector comprises a drop waveguide and a photodiode (both not shown). The drop waveguide is formed on the surface of photonic interposer 102 adjacent micro-ring modulator 312c such that the drop waveguide is electromagnetically coupled with micro-ring modulator 312c. The photodiode, attached to the surface of the dielectric layer, is optically connected to the drop waveguide and communicatively connected to chiplet 312. When the drop waveguide receives the modulated optical signal from micro-ring modulator 312c, the drop waveguide then provides the modulated optical signal to the photodiode, which proceeds to convert the optical signals into electrical signals. The electrical signals containing the encoded data are then provided to chiplet 312 where it is decoded and processed further. The electrical signals may also be simultaneously stored in memory module 312b for further processing. In embodiments of the disclosure, the high-speed photodetector may be provided adjacent to any micro-ring modulator shown in FIG. 3 where optical signals are to be converted into electrical signals for further processing by an associated chiplet.

In further embodiments of the disclosure, to ensure that the modulated optical signal from chiplet 318 is received by chiplet 312, the router controller will cause the micro-ring modulators of all remaining chiplets, i.e., chiplets 310, 311, 313, 314, 315, 316, 317—to resonate at wavelengths other than the first wavelength λ₁. This ensures that the modulated optical signal at the first wavelength λ₁ will not be intercepted by other chiplets other than the one for which the signal is intended for.

In further embodiments of the disclosure, while data is being exchanged between chiplets 318 and 312, communication may also take place concurrently between chiplets 316 and 314, as long as the communication occurs using an optical signal at a different wavelength, i.e. a second wavelength λ₂.

To initiate communication between chiplets 316 and 314, the router controller identifies and selects an optical signal at the second wavelength λ₂ from the combined multi-wavelength optical signals propagating through multimode waveguide 104. Micro-ring modulator 316c associated with chiplet 316 is then triggered to resonate at the second wavelength λ₂. As the combined optical signals pass by micro-ring modulator 316c, including the previously modulated optical signal at the first wavelength λ₁, only the optical signal at the second wavelength λ₂ is selectively electromagnetically coupled into micro-ring modulator 316c.

Once the optical signal at the second wavelength λ₂ is coupled into micro-ring modulator 316c, it is then modulated using the time-series data obtained from memory module 316b through changes in the refractive index of micro-ring modulator 316c, similar to the process described previously for chiplet 318.

After modulation, the optical signal at the second wavelength λ₂ exits micro-ring modulator 316c and re-couples into multimode waveguide 104. The combined optical signals in multimode waveguide 104 now carries the optical signals with encoded data at the first and second wavelengths λ₁ and λ₂ and propagates through the multimode waveguide towards their respective destinations. To ensure that the modulated optical signal at the second wavelength λ₂ reaches chiplet 314 without interference, the router controller ensures that the micro-ring modulators of other chiplets are either not resonating at the second wavelength λ₂ or are tuned to different wavelengths.

When the modulated optical signal at the second wavelength λ₂ approaches chiplet 314, the modulated optical signal is then selectively electromagnetically coupled into micro-ring modulator 314c, which has been triggered to resonate at the second wavelength λ₂. The modulated optical signal in micro-ring modulator 314c is subsequently coupled to a high-speed photodetector formed on the surface of photonic interposer 102 and is processed as previously described where the converted electrical signals may be provided to chiplet 314 or stored in memory module 314b.

In further embodiments of the disclosure, memory controller 320 may be provided on the surface of photonic interposer 102 and may be communicatively connected to all the memory modules provided in system 300. The function of memory controller 320 is to manage the interaction between each of the memory modules thereby ensuring that the modulation and/or processing by the respective chiplets are correctly stored and retrieved when required. Memory controller 320 also coordinates the timing and synchronization of data exchange between the memory modules and other components of system 300.

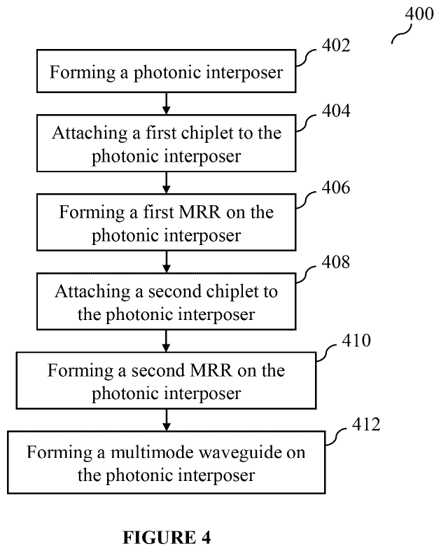

A process for fabricating or forming an optoelectronic device in accordance with an embodiment of this disclosure is illustrated in FIG. 4. Process 400 may be performed using standard semiconductor fabrication or manufacturing steps. Process 400 begins at step 402. At this step, a photonic interposer comprising a conductive layer interposed between a dielectric layer and a base substrate is initially formed. Specifically, process 400 first forms the conductive layer on the base substrate. The dielectric layer is then formed on the conductive layer.

At step 404, process 400 then attaches a first chiplet to a surface of the dielectric layer of the photonic interposer. Process 400 then forms a first micro-ring resonator (MRR) router on the surface of the dielectric layer adjacent to the first chiplet, where the first MRR router is communicatively connected to the first chiplet through a first conductive interconnect layer formed within the dielectric layer. This takes place at step 406. At step 408, process 400 then attaches a second chiplet to the photonic interposer. Process 400 then forms a second MRR router on the surface of the dielectric layer adjacent to the second chiplet, where the second MRR router is communicatively connected to the second chiplet through a second conductive interconnect layer formed within the dielectric layer and this occurs at step 410. Process 400 then proceeds to step 412 where process 400 forms a multimode waveguide on the surface of the dielectric layer adjacent to the first and the second MRR routers such that the multimode waveguide is electromagnetically coupled to the first and the second MRR routers. The multimode waveguide has a first end for receiving optical signals and a second end for transmitting optical signals.

In further embodiments of the disclosure, process 400 forms a high-speed photodetector on the surface of the dielectric layer adjacent to the second chiplet and the second MRR router, converts, using the high-speed photodetector, optical signals received by the second MRR router into electrical signals, and provides, using the high-speed photodetector, the converted electrical signals to the second chiplet.

In further embodiments of the disclosure, the high-speed photodetector comprises a drop waveguide and a photodiode. The drop waveguide is formed on the surface of the dielectric layer adjacent the second MRR router such that the drop waveguide is electromagnetically coupled with a micro-ring modulator of the second MRR router, and the photodiode is attached to the surface of the dielectric layer and optically connected to the drop waveguide while being communicatively connected to the second chiplet.

In further embodiments of the disclosure, process 400 forms a multi-wavelength multiplexer on the surface of the dielectric layer for receiving and combining multi-wavelength optical signals from a laser bank, and optically couples the multi-wavelength multiplexer to the first end of the multimode waveguide.

In further embodiments of the disclosure, process 400 resonates a micro-ring modulator of the first MRR router at a first wavelength, selectively couples, using the resonating micro-ring modulator of the first MRR router, an optical signal having the first wavelength from the combined multi-wavelength optical signals propagating in the multimode waveguide, modulates, using the resonating micro-ring modulator of the first MRR router, the coupled optical signal based on data contained in a memory module of the first MRR router, and couples, using the resonating micro-ring modulator of the first MRR router, the modulated optical signal to the multimode waveguide such that the coupled modulated optical signal propagates through the multimode waveguide.

In further embodiments of the disclosure, process 400 resonates a micro-ring modulator of the second MRR router at the first wavelength, selectively couples, using the resonating micro-ring modulator of the second MRR router, the modulated optical signal having the first wavelength from the optical signals propagating in the multimode waveguide, and optically couples, using the resonating micro-ring modulator of the second MRR router, the modulated optical signal to a high-speed photodetector formed on the surface of the dielectric layer adjacent to the second chiplet and the second MRR router.

In further embodiments of the disclosure, process 400 causes the first MRR router to modulate the coupled optical signal using electro-optic modulation or thermo-optic modulation. Process 400 also forms the base substrate from a thick silicon layer and the dielectric layer from a silicon dioxide layer.

In further embodiments of the disclosure, process 400 attaches a third chiplet to the surface of the dielectric layer of the photonic interposer. Process 400 then forms a third MRR router on the surface of the dielectric layer adjacent to the third chiplet and adjacent to the multimode waveguide such that the multimode waveguide is electromagnetically coupled to the third MRR router, the third MRR router being communicatively connected to the third chiplet through a third conductive interconnect layer formed within the dielectric layer, whereby the third MRR router is interposed in an optical signal path between the first and second MRR routers. Process 400 then resonates a micro-ring modulator of the third MRR router at a second wavelength and selectively couples, using the resonating micro-ring modulator of the third MRR router, an optical signal having the second wavelength from the combined multi-wavelength optical signals propagating in the multimode waveguide, whereby the modulated optical signal having the first wavelength continues to propagate through the multimode waveguide. Process 400 then modulates, using the resonating micro-ring modulator of the third MRR router, the coupled optical signal having the second wavelength based on data contained in a memory module of the third MRR router, and couples, using the resonating micro-ring modulator of the third MRR router, the modulated optical signal having the second wavelength to the multimode waveguide such that the coupled modulated optical signal having the second wavelength propagates through the multimode waveguide.

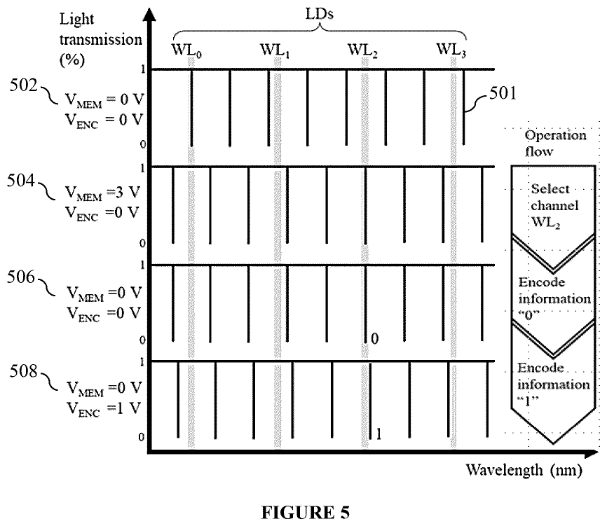

An operational flow of a MRR router in an optoelectronic device in accordance with an embodiment of the present disclosure is illustrated in FIG. 5. In this illustration, the combined optical signals propagating through the multimode waveguide comprises four optical signals at four different wavelengths, i.e., WL₀, WL₁, WL₂, WL₃.

Stage 502 represents the step where no action has been taken by a chiplet associated with the MRR router. Hence, it can be seen from light transmission signals 501 that the MRR router is not resonating at any of the four different wavelengths WL₀, WL₁, WL₂, WL₃.

Stage 504 represents the step where the optical signal at wavelength WL₂ is selected as the optical signal that is to be used as the photonic communication channel between chiplets of the optoelectronic device. At this stage, an appropriate biasing voltage, V_{MEM} is applied to the MRR router to cause the micro-ring modulator of the MRR router to resonate at the wavelength WL₂. As a result, light transmission signals 501 as illustrated in the plot at stage 504 are now shown to resonate at the wavelength WL₂ as well.

Stage 506 represents the step where the circulating optical signal at wavelength WL₂ is encoded with a bit of data representing a binary ‘0’. In this illustration, the encoding of the data is carried out by performing phase-shifts on the circulating optical signal. Hence, as a binary ‘0’ is to be encoded, the wavelength of the circulating optical signal is not “phase-shifted”.

Stage 508 represents the step where the circulating optical signal at wavelength WL₂ is encoded with a bit of data representing a binary ‘1’, and this is achieved by performing a phase-shift on the circulating optical signal. Hence, as shown in the plot at stage 508, it can be seen that light transmission signals 501 has been slightly phase-shifted to a higher wavelength.

The steps performed at stages 506 and 508 may then be repeated and/or altered as required until all the data has been encoded onto the optical signal. The encoded optical signal is then coupled back into the waveguide and communicated to the destination chiplet where it is decoded and processed accordingly. In embodiments of the disclosure, up to five (5) bits of data may be simultaneously encoded onto the optical signal.

### Simulation Results

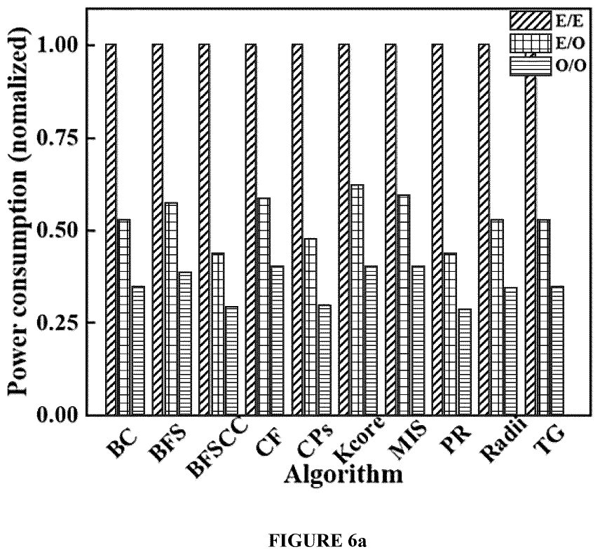

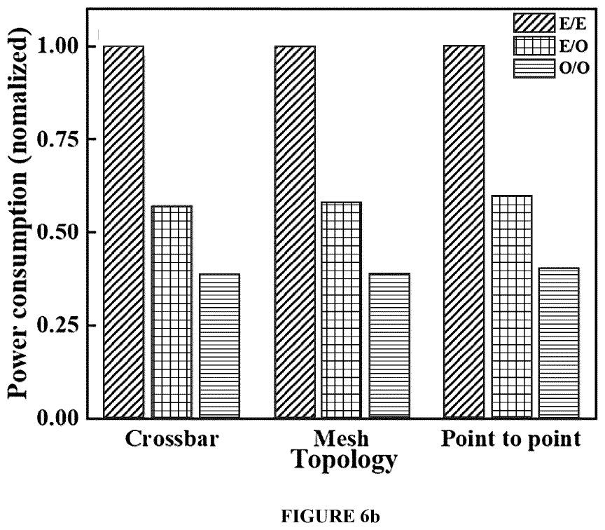

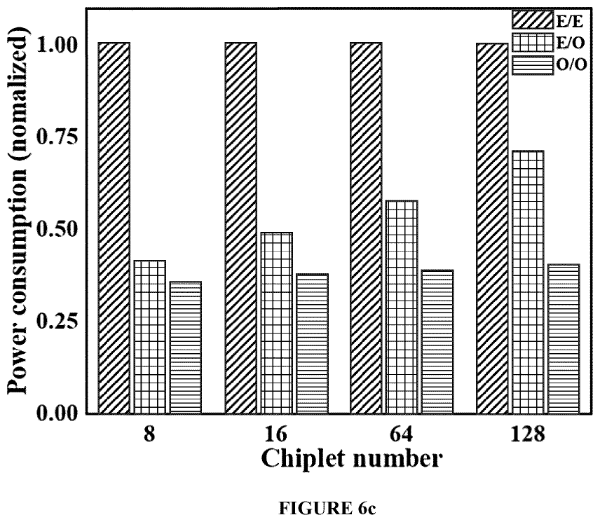

An optoelectronic device as described above is modeled using a 10 nm complementary metal-oxide-semiconductor (CMOS) technology. Benchmark tests are then performed on the simulated model based on different interconnect topologies such as electrical router/electrical interconnect (E/E), electrical router/optical interconnect (E/O) and optical router/optical interconnect (O/O), for various algorithms (see FIG. 6a), mesh topologies (see FIG. 6b) and chiplet numbers (see FIG. 6c). The algorithms plotted in FIG. 6a comprise betweenness centrality (BC), breadth-first search (BFS), breadth-first search connected components (BFSCC), clustering coefficient (CF), K-Core decomposition (Kcore), maximal independent set (MIS), Radii, components (CPs), page rank (PR) and triangle (TG) algorithms. The detailed workings of these algorithms are omitted for brevity as they are well known in the art.

Numerous other changes, substitutions, variations, and modifications may be ascertained by the skilled in the art and it is intended that the present application encompass all such changes, substitutions, variations and modifications as falling within the scope of the appended claims.

1. An optoelectronic device comprising:
a photonic interposer comprising:
a conductive layer formed on a base substrate;
a dielectric layer formed on the conductive layer such that the conductive layer is interposed between the dielectric layer and the base substrate;
a first chiplet attached to a surface of the dielectric layer of the photonic interposer;
a first micro-ring resonator (MRR) router disposed on the surface of the dielectric layer adjacent to the first chiplet, the first MRR router being communicatively connected to the first chiplet through a first conductive interconnect layer formed within the dielectric layer;
a second chiplet attached to the surface of the photonic interposer;
a second MRR router disposed on the surface of the dielectric layer adjacent to the second chiplet, the second MRR router being communicatively connected to the second chiplet through a second conductive interconnect layer formed within the dielectric layer;
a multimode waveguide having a first end for receiving optical signals and a second end for transmitting optical signals, the multimode waveguide being formed on the surface of the dielectric layer and positioned adjacent to the first and the second MRR routers such that the first and the second MRR routers electromagnetically couples with the optical signals within the multimode waveguide,
wherein the first and second MRR routers each comprise a micro-ring modulator and a memory module.

2. The optoelectronic device according to claim 1, further comprising:
a high-speed photodetector formed on the surface of the dielectric layer adjacent to the second chiplet and the second MRR router, the high-speed photodetector being configured to convert optical signals received by the second MRR router into electrical signals and to provide the converted electrical signals to the second chiplet.

3. The optoelectronic device according to claim 2, wherein the high-speed photodetector comprises a drop waveguide and a photodiode, wherein the drop waveguide is formed on the surface of the dielectric layer adjacent the second MRR router such that the drop waveguide electromagnetically couples with optical signals within a micro-ring modulator of the second MRR router, and the photodiode is attached to the surface of the dielectric layer and optically connected to the drop waveguide and communicatively connected to the second chiplet.

4. The optoelectronic device according to claim 1, further comprising:
a multi-wavelength multiplexer formed on the surface of the dielectric layer for receiving and combining multi-wavelength optical signals from a laser bank, the multi-wavelength multiplexer being optically coupled to the first end of the multimode waveguide.

5. The optoelectronic device according to claim 4, whereby a micro-ring modulator of the first MRR router is configured to:
resonate at a first wavelength;
selectively couple an optical signal having the first wavelength from the combined multi-wavelength optical signals propagating in the multimode waveguide;
modulate the coupled optical signal based on data contained in a memory module of the first MRR router; and
couple the modulated optical signal to the multimode waveguide such that the coupled modulated optical signal propagates through the multimode waveguide.

6. The optoelectronic device according to claim 5, whereby a micro-ring modulator of the second MRR router is configured to:
resonate at the first wavelength;
selectively couple the modulated optical signal having the first wavelength from the optical signals propagating in the multimode waveguide; and
coupling the modulated optical signal to a high-speed photodetector formed on the surface of the dielectric layer adjacent to the second chiplet and the second MRR router.

7. The optoelectronic device according to claim 5, wherein the first MRR router modulates the coupled optical signal using electro-optic modulation or thermo-optic modulation.

8. The optoelectronic device according to claim 1, wherein the base substrate comprises a thick silicon layer.

9. The optoelectronic device according to claim 1, wherein the dielectric layer comprises a silicon dioxide layer.

10. The optoelectronic device according to claim 1, further comprising:
a third chiplet attached to the surface of the dielectric layer of the photonic interposer;
a third MRR router disposed on the surface of the dielectric layer adjacent to the third chiplet and adjacent to the multimode waveguide such that the third MRR router electromagnetically couples with the optical signals within the multimode waveguide, the third MRR router being communicatively connected to the third chiplet through a third conductive interconnect layer formed within the dielectric layer, whereby the third MRR router is interposed in an optical signal path between the first and second MRR routers;
a micro-ring modulator of the third MRR router being configured to:
resonate at a second wavelength;
selectively couple an optical signal having the second wavelength from the combined multi-wavelength optical signals propagating in the multimode waveguide, whereby the modulated optical signal having the first wavelength continues to propagate through the multimode waveguide;
modulate the coupled optical signal having the second wavelength based on data contained in a memory module of the third MRR router; and
couple the modulated optical signal having the second wavelength to the multimode waveguide such that the coupled modulated optical signal having the second wavelength propagates through the multimode waveguide.

11. A method for forming an optoelectronic device, the method comprising:
forming a photonic interposer comprising the steps of:
forming a conductive layer on a base substrate;
forming a dielectric layer on the conductive layer such that the conductive layer is interposed between the dielectric layer and the base substrate;
attaching a first chiplet to a surface of the dielectric layer of the photonic interposer;
forming a first micro-ring resonator (MRR) router on the surface of the dielectric layer adjacent to the first chiplet, the first MRR router being communicatively connected to the first chiplet through a first conductive interconnect layer formed within the dielectric layer;
attaching a second chiplet to the surface of the photonic interposer;
forming a second MRR router on the surface of the dielectric layer adjacent to the second chiplet, the second MRR router being communicatively connected to the second chiplet through a second conductive interconnect layer formed within the dielectric layer;
forming a multimode waveguide, having a first end for receiving optical signals and a second end for transmitting optical signals, on the surface of the dielectric layer adjacent to the first and the second MRR routers such that the first and the second MRR routers electromagnetically couples with the optical signals within the multimode waveguide,
wherein the first and second MRR routers each comprise a micro-ring modulator and a memory module.

12. The method according to claim 11, further comprising the step of:
forming a high-speed photodetector on the surface of the dielectric layer adjacent to the second chiplet and the second MRR router;
converting, using the high-speed photodetector, optical signals received by the second MRR router into electrical signals; and
providing, using the high-speed photodetector, the converted electrical signals to the second chiplet.

13. The method according to claim 12, wherein the high-speed photodetector comprises a drop waveguide and a photodiode, wherein the drop waveguide is formed on the surface of the dielectric layer adjacent the second MRR router such that the drop waveguide electromagnetically couples with optical signals within a micro-ring modulator of the second MRR router, and the photodiode is attached to the surface of the dielectric layer and optically connected to the drop waveguide and communicatively connected to the second chiplet.

14. The method according to claim 11, further comprising:
forming a multi-wavelength multiplexer on the surface of the dielectric layer for receiving and combining multi-wavelength optical signals from a laser bank; and
optically coupling the multi-wavelength multiplexer to the first end of the multimode waveguide.

15. The method according to claim 14, further comprising the steps of:
resonating a micro-ring modulator of the first MRR router at a first wavelength;
selectively coupling, using the resonating micro-ring modulator of the first MRR router, an optical signal having the first wavelength from the combined multi-wavelength optical signals propagating in the multimode waveguide;
modulating, using the resonating micro-ring modulator of the first MRR router, the coupled optical signal based on data contained in a memory module of the first MRR router; and
coupling, using the resonating micro-ring modulator of the first MRR router, the modulated optical signal to the multimode waveguide such that the coupled modulated optical signal propagates through the multimode waveguide.

16. The method according to claim 15, further comprising the steps of:
resonating a micro-ring modulator of the second MRR router at the first wavelength;
selectively coupling, using the resonating micro-ring modulator of the second MRR router, the modulated optical signal having the first wavelength from the optical signals propagating in the multimode waveguide; and
optically coupling, using the resonating micro-ring modulator of the second MRR router, the modulated optical signal to a high-speed photodetector formed on the surface of the dielectric layer adjacent to the second chiplet and the second MRR router.

17. The method according to claim 15, wherein the first MRR router modulates the coupled optical signal using electro-optic modulation or thermo-optic modulation.

18. The method according to claim 11, wherein the base substrate comprises a thick silicon layer.

19. The method according to claim 11, wherein the dielectric layer comprises a silicon dioxide layer.

20. The method according to claim 11, further comprising the steps of:
attaching a third chiplet to the surface of the dielectric layer of the photonic interposer;
forming a third MRR router on the surface of the dielectric layer adjacent to the third chiplet and adjacent to the multimode waveguide such that the third MRR router electromagnetically couples with the optical signals within the multimode waveguide, the third MRR router being communicatively connected to the third chiplet through a third conductive interconnect layer formed within the dielectric layer, whereby the third MRR router is interposed in an optical signal path between the first and second MRR routers;
resonating a micro-ring modulator of the third MRR router at a second wavelength;
selectively coupling, using the resonating micro-ring modulator of the third MRR router, an optical signal having the second wavelength from the combined multi-wavelength optical signals propagating in the multimode waveguide, whereby the modulated optical signal having the first wavelength continues to propagate through the multimode waveguide;
modulating, using the resonating micro-ring modulator of the third MRR router, the coupled optical signal having the second wavelength based on data contained in a memory module of the third MRR router; and
coupling, using the resonating micro-ring modulator of the third MRR router, the modulated optical signal having the second wavelength to the multimode waveguide such that the coupled modulated optical signal having the second wavelength propagates through the multimode waveguide.
